(19) United States
(12) Patent Application Publication
(10) Pub. No.: US 2025/0065232 A1
(43) Pub. Date: Feb. 27, 2025

(54) Method Of Interacting With A Video Game System

(71) Applicant: Sony Interactive Entertainment Europe Limited, London (GB)

(72) Inventors: Andrew William Walker, London (GB); Atsushi Suganuma, London (GB); Calum Armstrong, London (GB); Damian O'Sullivan, London (GB)

(73) Assignee: Sony Interactive Entertainment Europe Limited, London (GB)

(21) Appl. No.: 18/810,860

(22) Filed: Aug. 21, 2024

(30) Foreign Application Priority Data
Aug. 23, 2023 (GB) GB2312882.0

(51) Int. Cl. A63F 13/67; A63F 13/218

(52) U.S. Cl. CPC A63F 13/67; A63F 13/218

(57) ABSTRACT

A computer-implemented method of interacting with a video game system comprising a user input device, the method comprising: determining movement of a user using a sensor; predicting a future actuation of the user input device based on the determined movement, wherein the actuation triggers a game event; outputting an effect based on the predicted actuation of the user input device. This provides accurate, pre-emptive effects and improves the interaction between a video game system and a user.

### CROSS-REFERENCE TO RELATED APPLICATION

The present application claims priority from United Kingdom Patent Application No. GB2312882.0 filed Aug. 23, 2023, the disclosure of which is hereby incorporated herein by reference.

### FIELD OF THE INVENTION

The present invention relates to the field of video game systems. In particular, the invention relates to computer-implemented methods for interacting with video game systems.

### BACKGROUND

Many video game systems include a controller as an input device, enabling a user to interact with a video game application (equivalently, ‘video games’) running on the system. Such controllers typically include one or more push-buttons (herein ‘buttons’), analogue sticks, and other input elements such as triggers or touchpads to be actuated by a user. Other types of user input devices may track the position of a user and even particular parts of a user such as their fingers or eyes.

A key aspect of video games is that they are interactive, meaning they can be controlled by a user (who may be using the controller) and respond to actuation of the input device. The response can take many forms such as an on-screen display, a change in the application itself or playback of an audio signal. Some controllers are also output devices and provide feedback to the user in response to operation of the controller and/or a virtual event occurring in the video game (such as a game event triggered by input element actuation). The controller feedback can be provided in a variety of manners, such as audio output provided by a speaker of the controller, visual output provided by a light or display of the controller, or haptic output provided by a haptic module of the controller. Output can also be provided by other devices such as a display, headphones, or speakers.

However, a limitation of this feedback is that it is reactive-it responds to the user input device being actuated. This limits the type of feedback that can be provided to a user and can present a noticeable delay between the actuation of a user input device and the subsequent corresponding output effect.

It is therefore desirable to provide improved methods of interacting with a video game system.

### SUMMARY OF INVENTION

In a first aspect of the invention there is provided a computer-implemented method of interacting with a video game system comprising a user input device, the method comprising: determining movement of a user using a sensor; predicting a future actuation of the user input device based on the determined movement, wherein the actuation triggers a game event; outputting an effect based on the predicted actuation of the user input device.

A game event is a change in the state of a video game application running on the video game system. This may take many different forms depending on the video game application being run, and the current state of the application. For example, the game event may be a dialogue choice, selection of an option in a menu, an action of a player character such as movement or swinging a sword. Other suitable game events will be appreciated by the skilled person with the benefit of the present disclosure.

The effect may be output by the video game system or a peripheral in communication with the system, such as an external display, speaker, or headphones. The type of effect output may also depend on the device which is outputting it. For example, a controller comprising a light source, haptic module and speaker can output effects which are visual, haptic, and audio outputs. In another example, a pair of standard headphones in communication with the video game system may only be able to output effects which are audio outputs—other types of effects such as visual, smell, taste and haptic outputs must be output by another device.

Predicting a future actuation of the user input device refers to predicting whether the user input device will be actuated in the future, and when this actuation will occur. The exact nature of this predicting may take many forms and is not limited herein. The determined speed and direction of the movement of the user relative to the user input device may be considered (either in isolation or in combination with other factors such as user history and confidence thresholds) and future actuation of the user input device is predicted based on this. For example, where the user input device is a controller and it is determined the user is moving away from the controller, this indicates the user is unlikely to actuate an input element of the controller. In contrast, where it is determined the user is moving closer to the controller this indicates the user is more likely to actuate an input element, and a future actuation of the input element may be predicted based on this movement.

The prediction may be updated based on updated determined movement(s) of the user relative to the user input device. For example, if the speed or direction of movement of the user changes then this will affect the likelihood of whether and when a future actuation of the user input device will occur.

The present disclosure refers to a user actuating the user input device, however it will be appreciated that the invention does not require the user to directly actuate the user input device. That is, the invention also encompasses the user indirectly actuating the user input device (e.g. using another object to actuate the user input device rather than actuating it directly).

By predicting a future actuation of a user input device and outputting an effect based on this predicted actuation, the method of the present invention is able to provide accurate, pre-emptive effects and improve the interaction between a video game system and user.

The effect may be generated after predicting the future actuation of the user input device, alternatively the effect may already be prepared and stored prior to the predicting step and retrieved after the predicting for later output. The origin of the output effect is not limited in the present invention.

It will be appreciated that predicting an upcoming actuation and outputting an effect (e.g. a pre-emptive effect and/or actuation effect output) based on that prediction is different from defining multiple discrete actuations and corresponding outputs associated with each actuation (e.g. multiple target locations where the user input device is a user-tracking module or an eye-tracking module, with an effect output triggered by each actuation).

Optionally, the user input device comprises a controller comprising an input element, wherein the sensor is configured to determine a movement of the user relative to the input element of the controller to predict a future actuation of the input element. Actuation of the input element of the controller is actuation of the controller (i.e. actuation of the user input device).

Determining the movement of the user relative to the controller may comprise determining the movement of a hand of the user relative to the input element. This may comprise determining the movement of a part of the hand of the user, such as a finger or thumb, relative to the input element.

The sensor may comprise a proximity sensor, a pressure sensor, a motion detector, a capacitive touch sensor, and/or a galvanic skin response sensor. These are examples of types of sensors which may be used to determine movement of the user relative to the controller. Some of these sensors, such as the proximity sensor and motion detector, can determine movement of the user without contacting the user. Other sensors such as the pressure sensor, capacitive touch sensor, and galvanic skin response sensor determine movement of the user through (direct or indirect) contact between the user and the sensor.

The controller may comprise the sensor. Having the controller comprise at least one sensor facilitates more accurate determining of the movement of the user relative to the controller, and so also more accurate actuation predictions. Alternatively, the sensor may be separate from the controller. It will be appreciated that one or more sensors used for determining movement may be comprised in the controller, while one or more sensors also used for determining movement may be external sensors and not comprised in the controller. For example, the controller may comprise a proximity sensor and capacitive touch sensor, while a motion detector separate from the controller is used in combination with the sensors of the controller to determine the movement of the user.

The sensor may comprise a pressure sensor connected to the input element and configured to determine an amount of pressure applied to the input element by the user. Providing a sensor in this manner facilitates the accurate determination of movement of a user.

For example, where the input element is a button with binary on/off states, a pressure sensor connected to the button can detect when a user is touching the button but has not actuated it, as well as the travel of the button between the off state and on state as the user begins to actuate the button, thereby determining movement of the user relative to the controller. The pressure sensor may be directly connected to the input element or indirectly connected using an intermediate element.

The sensor may also be arranged adjacent to the input element. In this way, the sensor can easily and accurately track the movement of the user relative to the input element.

The sensor may comprise a proximity sensor and/or a motion detector arranged on the interior of the controller, wherein the input element is transparent to the proximity sensor and the motion detector.

The input element being transparent means that the sensor(s) do not determine movement of the input element, or that movement of the input element is ignored. Arranging the sensor inside the controller in this manner means it is able to determine movement of the user while preventing contact with the user, thereby protecting the sensor and extending the lifetime of the component.

It will be appreciated that the method is suitable for predicting a future actuation of a digital input element (i.e. an input element with binary on/off states) as well as predicting a future actuation of an analogue input element. A button and a digital trigger are both examples of common digital input elements, with an analogue stick and an analogue trigger being common examples of analogue input elements.

Optionally, the user input device comprises a user-tracking module configured to receive an actuation input when a user is located at a particular target location, where the sensor is configured to determine an initial movement of the user to predict the user being located at the target location in future.

Using the user-tracking module in this way is particularly useful when applying the method with video game systems that employ virtual reality (VR) or augmented reality (AR). For example, if it is determined the user is moving away from the target location, this indicates the user is unlikely to trigger an actuation input (i.e. for the user-tracking module to receive an actuation input). In contrast, where it is determined the user is moving closer to the target location this indicates the user is more likely to trigger an actuation input, and it is predicted that the user will be located at the target location in the future and so the user-tracking module will receive an actuation input in the future.

The user being located at the target location may refer to the whole body of the user or a part of the user, such as their arm, leg, hand, foot, finger, or thumb being located at the target location. Similarly, the initial movement of the user may refer to the initial movement of the whole body of the user or a part of the user.

Optionally, the user input device comprises an eye-tracking module configured to receive an actuation input when a user looks at a particular target location, where the sensor is configured to determine an initial movement of the user's eye to predict the user looking at the target location in future.

Movement of the user's eye refers to the gaze of the user, i.e. where the user is looking. Using the user-tracking module in this way is particularly useful when applying the method with video game systems that employ VR or AR. For example, if it is determined the user's eye is moving away from the target location, this indicates the user is unlikely to trigger an actuation input (i.e. for the user-tracking module to receive an actuation input). In contrast, where it is determined the user's eye is moving closer to the target location this indicates the user is more likely to trigger an actuation input, and it is predicted that the user will look at the target location in the future and so the user-tracking module will receive an actuation input in the future.

The effect output based on the predicted actuation of the user input device may be a pre-emptive effect and/or an actuation effect.

Optionally, outputting the effect may comprise outputting a pre-emptive effect prior to actuation of the user input device, based on the predicted actuation of the user input device.

The pre-emptive effect provides stimulus to the user, after it has been predicted they will actuate the user input device in the future and prior to the actuation of the user input device. The stimulus provided by the pre-emptive effect will depend on the characteristics of the pre-emptive effect (e.g. the amplitude, frequency, whether it is audio, haptic or visual), and can assist the user in operation of the user input device in the form of a visual, audible or tactile aid.

The magnitude of the output pre-emptive effect may be based on the determined movement of the user. For example, the magnitude of the output pre-emptive effect may vary based on the distance between the user and the input element of the controller, or the magnitude of the output pre-emptive effect may vary based between the user and the target location. In some examples, the magnitude of the output pre-emptive effect may increase or decrease as the user moves closer to the controller, or as the user moves closer to the input element of the controller. In other examples where the user input device comprises the user-tracking module, the magnitude of the output pre-emptive effect may increase or decrease as the user moves closer to the target location. Similarly, when the user input device comprises the eye-tracking module, the magnitude of the output pre-emptive effect may increase or decrease as the user's gaze moves closer to the target location.

The magnitude of the output pre-emptive effect may be based on the length of time the user has been within a proximity threshold around the controller, around the input element of the controller, or around the target location. For example, the magnitude of the output pre-emptive effect may increase or decrease the longer the user is within the proximity threshold.

The type of the output pre-emptive effect may be based on the determined movement of the user. For example, for a given determined movement the output pre-emptive effect may only include haptic output, while the output pre-emptive effect for another determined movement may include haptic output and audio output.

Basing the magnitude and/or type of the output pre-emptive effect on the determined movement in this way allows for a more detailed effect to be generated which more directly corresponds to the user's movement and actuation of the user input device. These techniques may emphasise the significance of the corresponding game event which will be triggered by the actuation. For example, the pre-emptive effect may initially include only a haptic output and later include both a haptic output and an audio output as the user moves closer to an input element of the controller.

Optionally, outputting the effect may comprise: caching an actuation effect prior to actuation of the user input device; and outputting the actuation effect after actuation of the user input device.

The actuation effect is the effect provided in response to actuation of the user input device. As actuation of the user input device triggers a game event, the actuation event may also be considered the effect provided in response to triggering of the game event (i.e. the effect corresponding to the triggered game event). By predicting a future actuation of a user input device and caching an actuation effect prior to actuation of the user input device, when the user input device is actuated the cached actuation effect may be served and output faster than would otherwise be achieved. This reduces the delay between actuation of the input event and output of a corresponding output effect.

This process of caching and outputting the actuation effect may be performed independently of the above process relating to the pre-emptive effect, or in combination with the process relating to the pre-emptive effect.

Determining the movement of the user relative to the controller may comprise determining the movement of a hand of the user relative to the controller, and/or relative to the input element of the controller.

Input elements of controllers are commonly actuated by a finger and/or thumb of a user, therefore determining the movement of a hand (and optionally, a finger and/or thumb) of the user relative to the controller provides more accurate prediction of the future actuation.

A more accurately predicted future actuation increases the accuracy of an output pre-emptive effect, reduces the likelihood of caching an incorrect actuation effect which does not correspond to the actuation of the user input device, and reduces the likelihood of missing caching the correct actuation effect corresponding to actuation of the user input device.

Determining the movement of the user may comprise determining the movement of the user relative to the input element. In this way, the method provides a more accurate prediction of the future actuation of the input element.

Predicting the future actuation of the input element based on the determined movement may comprise: applying a trained machine learning model to the determined movement, wherein the trained machine learning model is configured to output the predicted future actuation from the determined movement.

The above methods may be performed by the video game system, a device thereof, and/or a device in communication with the video game system such as an external speaker, display, server or cloud service.

In a second aspect of the invention, there is provided a video game system comprising a sensor, and at least one of a controller, a user-tracking module, and an eye-tracking module, wherein the system is configured to perform a method according to the first aspect.

According to a third aspect, there is provided a computer program comprising computer-readable instructions which, when executed by one or more processors, cause the one or more processors to perform a method according to the first aspect.

According to a fourth aspect, there is provided a non-transitory storage medium storing computer-readable instructions which, when executed by one or more processors, cause the one or more processors to perform a method according to the first aspect.

### BRIEF DESCRIPTION OF DRAWINGS

Embodiments of the invention are described below, by way of example only, with reference to the accompanying drawings, in which:

FIG. 1A schematically illustrates a controller for a video game system;

FIG. 1B schematically illustrates a cross-sectional view of a portion of the controller of FIG. 1A;

FIG. 2 is a flow chart showing an example of a method in accordance with an embodiment of the invention; and

FIGS. 3A-3C each schematically illustrate a cross-sectional view of a user in different positions relative to an input element of a controller.

### DETAILED DESCRIPTION

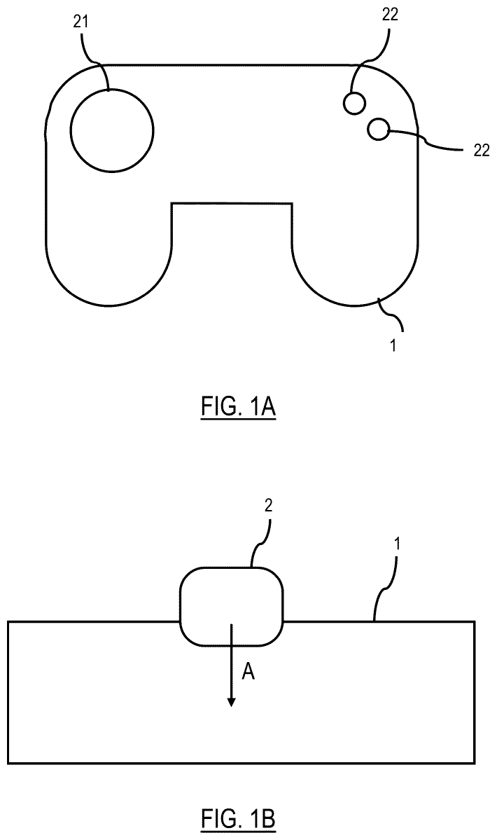

Referring to FIG. 1A, a controller 1 for a video game system (equivalently, ‘gaming system’) is shown. The controller 1 includes input elements that a user can operate to provide input to the gaming system. In this example, the input elements of the controller 1 in FIG. 1A include an analogue stick 21 and two buttons 22.

FIG. 1B shows a cross-sectional view of a portion of the controller 1, highlighting a portion of the controller 1 with an input element 2. In this example, the input element 2 is a button which may be actuated by pressing the input element in the direction of the arrow A (towards the interior of the controller 1). When the input element 2 has moved to a specified position or past a particular threshold, the input element 2 has been actuated, input is registered and sent to the video game system—thereby triggering a game event. Typically, a button type input element 2 is biased in the opposite direction to the actuation direction A to maintain an un-actuated state as the ‘rest’ state.

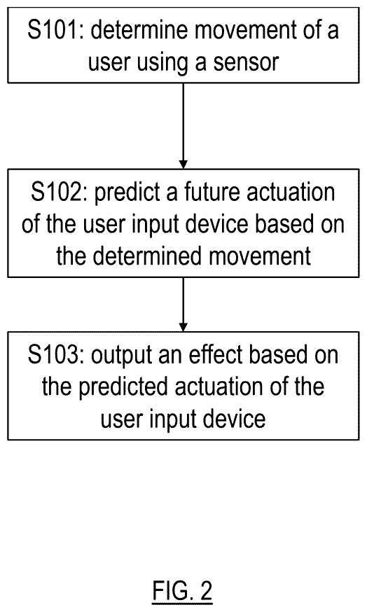

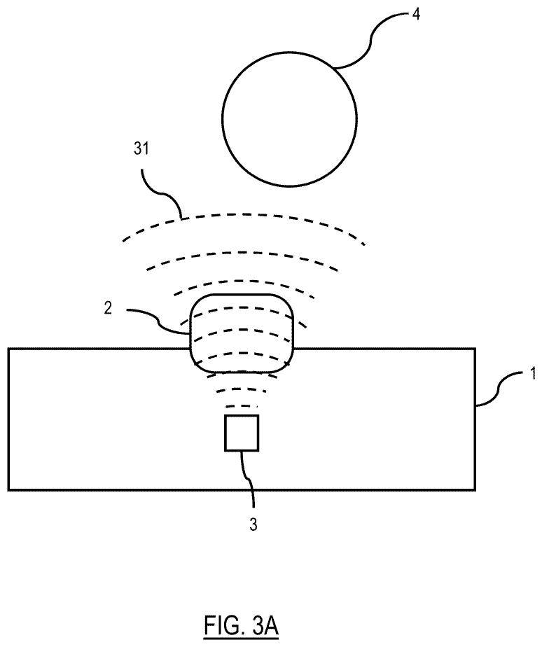

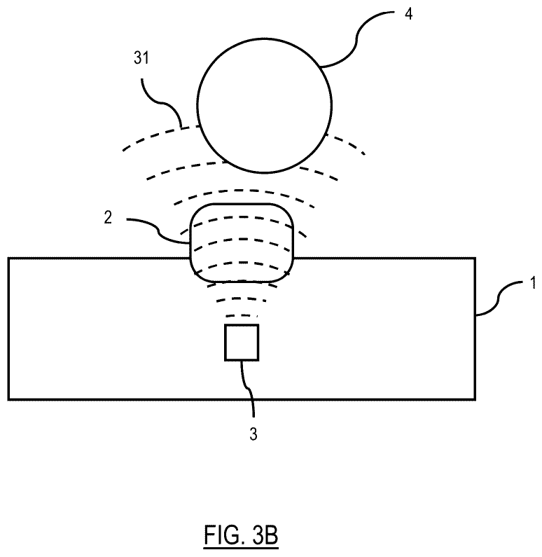

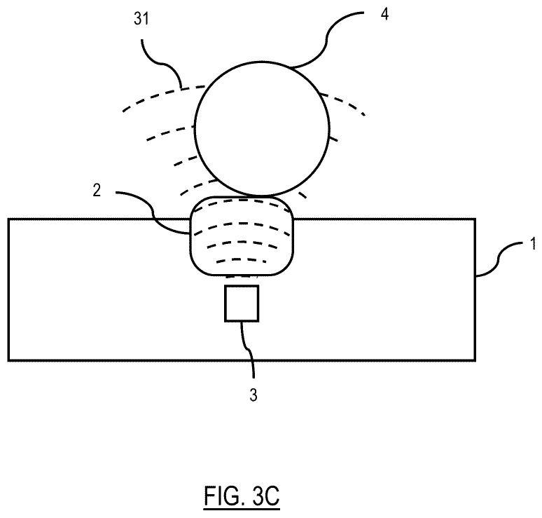

FIG. 2 is a flow chart showing the steps of an example of a method in accordance with an embodiment of the invention. References will be made to FIGS. 3A, 3B, and 3C as an illustrative example of the method of FIG. 2 in use. In this example, the input element 2 is a push-button however it will be appreciated that the method of the invention may be applied to other types of input elements not shown in the figures.

In step S101, movement of a user is determined using a sensor. In this example, the movement of the user is determined relative to a controller. In FIGS. 3A-3C, the sensor 3 is a proximity sensor 3 within the controller 1 capable of sensing the proximity of objects to the sensor 3 and, by extrapolation, the proximity to other parts of the controller 1. The sensor 3 emits electromagnetic radiation 31 (illustrated by dashed lines) and senses changes in a return signal to detect the presence of nearby objects without physical contact.

As shown in FIGS. 3A-3C, the sensor 3 is arranged on the interior of the controller 1 beneath the input element 2. The input element 2 is configured to allow at least some of the electromagnetic radiation 31 to pass through the input element 2 into the area surrounding the controller 1.

The sensor 3 senses the proximity of the user 4 (in particular, a nearby part of the user 4 such as their hand, finger, or thumb) at different points in time, with changes in the sensed proximity of the user 4 being used to calculate the movement of the user 4 relative to the controller 1. Comparing FIGS. 3A and 3B, if the event of FIG. 3A is at a point in time before the event of FIG. 3B then the sensor 3 will determine the user 4 is moving towards the controller 1 (and in particular to the input element 2). If the inverse is true, where the event of FIG. 3A is at a point in time after the event of FIG. 3B, then the sensor 3 will determine that the user 4 is moving away from the controller 1 (and in particular from the input element 2).

In step S102, a future actuation of the user input device is predicted based on the determined movement. Continuing with the example where the event of FIG. 3A is before the event of FIG. 3B, it has been determined the user 4 is moving towards the input element 2 of the controller 1 and a future actuation of the input element 2 is predicted to occur at a given time in the future. This prediction can be continually updated as the movement of the user 4 continues to be determined using the sensor 3, allowing the predicted actuation to be as accurate as possible.

In some examples, a trained machine learning model is used to predict the future actuation of the input element 2. The determined movement is applied as the input to the model and the model is trained to output a predicted future actuation based on this input. The model may be trained on a data set obtained by user(s) 4 playing a video game, for example by recording movements of the user 4 and actuations of the input element 2. When training the model, the recorded movements are mapped to the recorded actuations of the input element 2. Optionally, other factors such as the video game state (e.g. what game or level is being played) and historical data of the user and/or other users may also be used as inputs when training the model and when using the trained model to predict a future actuation. This may provide more accurate predictions.

In some examples of the invention, the model is fully trained prior to implementation for predicting a future actuation. In other examples, the model may continue to record movement data and actuation data, using this recorded data to continually train and update the model in the manner described above.

In step S103, an effect is output based on the predicted actuation of the user input device. The effect includes audio, visual, smell, taste, and/or haptic outputs, with the exact nature of the effect depending on the determined movement of the user 4 and the game event which will be triggered by the actuation that has been predicted. For example, the effect may be a rumble or vibration produced by a haptic module, an audio signal played on a speaker or headphones, or a light which may flash or change colour. The effect may also be accompanied by an actual input to the video game system—for example to trigger a pre-emptive process in anticipation of actuation of the input.

FIG. 3C shows a point in time after the representation of FIGS. 3A and 3B, where the user 4 has actuated the input element 2 by pressing it towards the interior of the controller 1.

The effect may be a pre-emptive effect which is output prior to actuation of the input element 2—that is, the pre-emptive effect is output before the user 4 actuates the input element 2. The timing and nature (e.g. magnitude and type) of the pre-emptive effect output will be determined at least in part on the determined movement of the user 4 and the prediction of the future actuation of the input element 2. For example, once the future actuation of the input element 2 has been predicted, a haptic module may begin to output a pre-emptive effect which is a low amplitude rumble. As the user 4 moves closer to the input element 2, the output pre-emptive effect may change (or a new pre-emptive effect may be output) such that the haptic module outputs a rumble with higher frequency and amplitude-guiding the user 4 in actuating the input element 2 and indicating the significance of the game event which will be triggered by the impending predicted actuation. Continuing the example, as the user 4 moves closer still to the input element 2, the output pre-emptive effect may change again to further include an audio output.

Alternatively or in addition to the pre-emptive effect, the effect may be an actuation effect which is output after actuation of the input element 2. Actuation effects generally correspond to a game event triggered by actuation of the input element 2 to enhance the game event and player experience. It is desirable for the actuation effect to be output at the same time as the actuation itself, however in practice this instantaneous output is not realistic. For example due to necessary processing relating to actuation of the input element 2, the game event, transmitting signals and/or loading resources.

To reduce this delay, the actuation effect is cached prior to actuation of the input element 2, for subsequent outputting after actuation of the input element 2. That is, once the future actuation of the input element 2 has been predicted, the actuation effect is cached so that it can be served and output faster once the input element 2 has been actuated.

As the output actuation effect will correspond to the game event triggered by the actuation of the input element 2, a large number of different game events may be triggered in response to an individual input element 2 being actuated, with the specifically triggered game event depending on the game state when the input element 2 is actuated. Caching all possible actuation effects may be difficult, but by predicting when an actuation will occur based on the movement of the user 4, the method can also predict the actuation effect corresponding to the soon to be triggered game event such that only the corresponding actuation effect needs to be cached.

The examples above describe the invention in the context of a user input device which comprises a controller 1 with an input element 2. It will be apparent that the invention may be implemented and provide advantages with other user input devices.

For example, the user input device may comprise a user-tracking module configured to track the location of a user (and/or a specific part of a user such as their arm or hand) and receive an actuation input when the user is located at a particular target location. In another example, the user input device may comprise an eye-tracking module configured to track the eye of a user (i.e. the direction of the user's gaze) and receive an actuation input when the user looks at a particular target location.

The user-tracking module may receive the actuation input when the user (or the specific part of the user) reaches the target location or is located at the target location for a given period of time. The method may function similarly when the user input device comprises an eye-tracking module, which may receive the actuation input when the user first looks at a particular target location, or when the user looks at the target location for a given period of time. Using the present methods to predict this future actuation based on the movement of the user means that an effect may be cached or output before the user (and/or their gaze) reaches the target location.

Having described aspects of the disclosure in detail, it will be apparent that modifications and variations are possible without departing from the scope of aspects of the disclosure as defined in the appended claims. As various changes could be made in the above methods and products without departing from the scope of aspects of the disclosure, it is intended that all matter contained in the above description and shown in the accompanying drawings shall be interpreted as illustrative and not in a limiting sense.

1. A computer-implemented method of interacting with a video game system comprising a user input device, the method comprising:
determining movement of a user using a sensor;
predicting a future actuation of the user input device based on the determined movement, wherein the actuation triggers a game event; and
outputting an effect based on the predicted actuation of the user input device.

2. The method of claim 1, wherein the user input device comprises a controller comprising an input element, wherein the sensor is configured to determine the movement of the user relative to the input element of the controller to predict a future actuation of the input element.

3. The method of claim 2, wherein determining the movement of the user relative to the controller comprises determining a movement of a hand of the user relative to the input element.

4. The method of claim 2, wherein the sensor comprises at least one of a proximity sensor, a pressure sensor, a motion detector, a capacitive touch sensor, or a galvanic skin response sensor.

5. The method of claim 2, wherein the controller comprises the sensor and the sensor comprises a pressure sensor configured to determine an amount of pressure applied to the input element by the user.

6. The method of claim 2, wherein the controller comprises the sensor and the sensor comprises at least one of a proximity sensor or a motion detector arranged on an interior of the controller and adjacent to the input element, the input element being transparent to the at least one proximity sensor or motion detector.

7. The method of claim 2, wherein the input element is at least one of a button, a trigger, or an analogue stick.

8. The method of claim 1, wherein:
the user input device comprises a user-tracking module configured to receive an actuation input when a user is located at a target location; and
the sensor is configured to determine an initial movement of the user to predict the user being located at the target location.

9. The method of claim 1, wherein:
the user input device comprises an eye-tracking module configured to receive an actuation input when a user looks at a target location; and
the sensor is configured to determine an initial movement of an eye of the user to predict the user looking at the target location.

10. The method of claim 1, wherein outputting the effect comprises outputting a pre-emptive effect, prior to actuation of the user input device, based on the predicted actuation of the user input device.

11. The method of claim 10, wherein a magnitude of the pre-emptive effect is based on the determined movement of the user.

12. The method of claim 10, wherein a type of the pre-emptive effect is based on the determined movement of the user.

13. The method of claim 10, wherein:
the user input device comprises a controller comprising an input element; and
a magnitude of the pre-emptive effect varies based on the distance between the user and the input element of the controller.

14. The method of claim 10, wherein:
the user input device comprises a controller comprising an input element; and
a magnitude of the pre-emptive effect varies based on a length of time the user has been within a proximity threshold around the input element of the controller.

15. The method of claim 10, wherein:
the user input device comprises a controller comprising an input element; and
the pre-emptive effect is output by the controller.

16. The method of claim 10, wherein:
the user input device comprises a user-tracking module configured to receive an actuation input when a user is located at a target location;
the sensor is configured to determine an initial movement of the user to predict the user being located at the target location; and
a magnitude of the pre-emptive effect increases as the user moves closer to the target location.

17. The method of claim 10, wherein:
the user input device comprises an eye-tracking module configured to receive an actuation input when a user looks at a target location;
the sensor is configured to determine an initial movement of an eye of the user to predict the user looking at the target location; and
a magnitude of the pre-emptive effect increases as the eye of the user moves closer to the target location.

18. The method of claim 1, wherein outputting the effect comprises:
caching an actuation effect prior to actuation of the user input device; and
outputting the actuation effect after actuation of the user input device.

19. The method of claim 1, wherein predicting the future actuation of the user input device based on the determined movement comprises applying a trained machine learning model to the determined movement, wherein the trained machine learning model is configured to output the predicted future actuation from the determined movement.

20. A video game system comprising:
a sensor; and
a user input device comprising at least one of a controller, a user-tracking module, or an eye-tracking module;
wherein the system is configured to perform the method of claim 1.
